(19) United States
(12) Patent Application Publication
(10) Pub. No.: US 2004/0189828 A1
(43) Pub. Date: Sep. 30, 2004

(54) Method and apparatus for enhancing a paintball video

(76) Inventors: Bradley A. DeWees, Blaine, MN (US); Mindy M. DeWees, Blaine, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/397,034

(22) Filed: Mar. 25, 2003

(51) Int. Cl. H04N 5/262

(52) U.S. Cl. 348/239

(57) ABSTRACT

An apparatus, system and method for combining actual footage of game play with a time-accurate, graphical, overhead depiction of a playing field is disclosed. In a preferred embodiment, a team paintball game is simultaneously filmed from different vantage points using fixed cameras, roving cameras and an elevated camera. Player movement, location and other events captured by the cameras are converted into an overhead, graphical depiction that represents the game play. The graphical depiction is merged with a time-sequenced video stream comprising selected video footage captured by the cameras such that a completed video simultaneously depicts selected action footage with a time-accurate, overhead, graphical depiction of the entire playing field.

### FIELD OF THE INVENTION

The present invention relates generally to the sport of paintball. More specifically, the present invention relates to a time synchronized paintball video that combines video footage of actual gameplay with a simultaneous, graphical overhead depiction of player location and movement.

### BACKGROUND OF THE INVENTION

The sport of paintball has evolved markedly over the past 30 years. Originally, paintball technology was developed for use in marking cattle and trees. In the first paintball games, groups of friends would enter the woods and play various forms of capture-the-flag. From its humble beginnings, paintball has gone international and is currently played by over eleven million people worldwide. This enormous growth has created a large market for paintball equipment and accessories. Another response to this growth has been the formation of various leagues and tournaments for team paintball.

Team paintball typically comprises a pair of teams, each team usually consisting of five or 10 players, competing in a bounded area, or playing field, to score the most points in a given time frame. The playing field is most typically rectangular and is staked off by a visible string or ribbon. Within the playing field are a variety of obstacles, or bunkers, offering the teams protection and cover as they move about the field. The playing field typically includes a variety of flag stations, including one for each team or one in the center. The teams receive points in various ways, such as eliminating opposing players by shooting them with paintballs, by avoiding elimination, by grabbing the opposing team's flag or center flag and by returning the flags to their team's origination point. In team paintball, a judge or referee is present during the game and awards the points. The team with the most points at the end of the time period, typically not to exceed 15 minutes, is declared the winner. An example of team paintball format and rules is contained within Paintball Sports Promotions 2003 Official Rules For Competition Paintball, which is hereby incorporated by reference in its entirety.

Team paintball is enjoyed by all levels of players, ranging from beginners all the way through professional teams. In the United States, it is estimated that there are currently over 5,000 competing teams playing in over 220 events each year. This has led to the creation of various media outlets, including print and video, to cover and supply information relating to such events.

### SUMMARY OF THE INVENTION

The paintball video of the present invention provides an exciting and informative depiction of team paintball events. The paintball video of the present invention combines exciting video depiction of actual game play with a simulated, graphical depiction of overall team movement and location. The paintball video can function as mere entertainment or it can be used by teams to review and plan strategy for future events. In addition, the paintball video of the present invention is available in formats easily accessible to the average consumer.

In one aspect, the present invention relates to a paintball video for individual viewing. The paintball video comprises a media that is easily accessible to average consumers. The subject matter of the paintball video is usually a tournament in which a number of individual games have been played. The video comprises a screen split into two portions; a first portion in which selected video footage of the game action is replayed and the second portion being a simulated overhead, graphical depiction of team movement and location. The first video portion and the second graphical portion are time synchronized such that the action depicted in the video is consistent with the action depicted in the graphics. In its most preferred form, the video is supplied in a DVD format having multiple games from a single tournament whereby a viewer can easily select individual games to view.

In another aspect, the present invention relates to a method for creating a paintball video that simultaneously depicts video action with a simulated, overhead graphical depiction of team movement and location. Video action is accumulated during game play through the use of a combination of fixed and roving video cameras. A separate video camera is placed in an elevated position to capture team movement and location within the entire playing field. The elevated video is converted into a graphical, overhead depiction of the team movement whereby the players and the field are represented by a variety of shapes and colors. The video action footage and graphical, overhead depiction are then time synchronized and combined into a single video format.

In another aspect, the present invention relates to a system for making a paintball video that simultaneously depicts video action with a simulated, overhead graphical depiction of team movement and location. The system includes a series of fixed and roving cameras to capture player action, an elevated camera to capture team movement and location within the playing field, a graphics system for converting the information from the elevated camera into a graphical depiction, a tracking system for recording player movement and other events and a video editing system for combining and synchronizing the player footage with the graphical depiction.

### BRIEF DESCRIPTION OF THE DRAWINGS

FIG. 1 is a flow chart of the methodology used to create a paintball video of the present invention;

FIG. 2 is a top view of a playing field used in team paintball;

FIG. 3 is a flow chart of a tracking process;

FIG. 4 is a top view of a blank positioning sheet;

FIG. 5 is a top view of a completed positioning sheet for a single player;

FIG. 6 is a top view of a completed position sheet for a plurality of players;

FIG. 7 is a flow chart an animation process;

FIG. 8 is an exploded, perspective view of an object stack;

FIG. 9 is a top view of an animated overhead view;

FIG. 10 is a top view of an animated overhead view;

FIG. 11 is a top view of an animated overhead view;

FIG. 12 is a top view of an animated overhead view;

FIG. 13 is a top view of an animated overhead view;

FIG. 14 is a top view of an animated overhead view;

FIG. 15 is a timeline representing a player's movement;

FIG. 16 is an exploded, perspective view of the paintball video;

FIG. 17 is a top view of an animated overhead view including a highlighted elimination; and

FIG. 18 is a top view of an animated overhead view including a highlighted elimination.

### DETAILED DESCRIPTION OF THE DRAWINGS

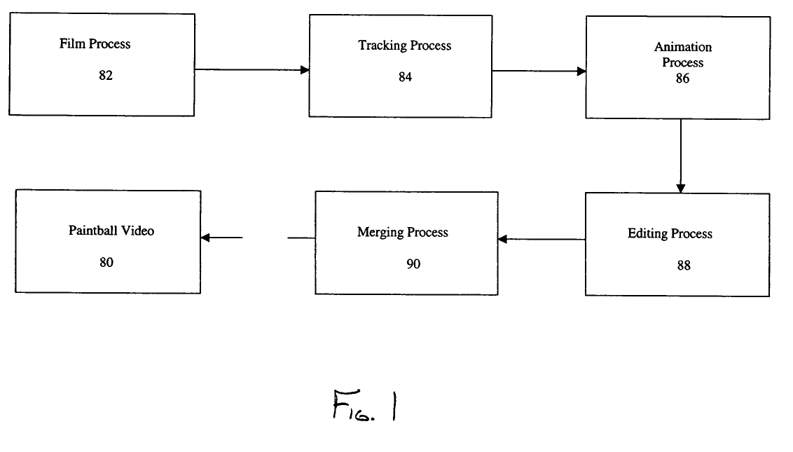

FIG. 1 depicts a flow chart of a preferred methodology by which an embodiment of a paintball video 80 of the present invention is created. Paintball video is preferably supplied in a DVD format but can be supplied in various other formats such as on CD-ROM, VHS, Beta, etc. First, a film process 82 is performed in which a paintball game is filmed from-multiple perspectives. Second, a tracking process 84 by which movement and positioning of players is tracked and recorded based on footage obtained during film process 82. Third, an animation process 86 in which the player movement and positioning obtained during tracking process 84 is converted into an overhead, graphical representation. Fourth, an editing process.88 in which action footage taken during film process 82 is reviewed, selected and combined into a continuous video stream. Fifth, a merging process 90 in which the overhead, graphical representation created in the animation process 86 is merged with the continuous video stream created in editing process 88 to create a single and simultaneous, dual view paintball video 80.

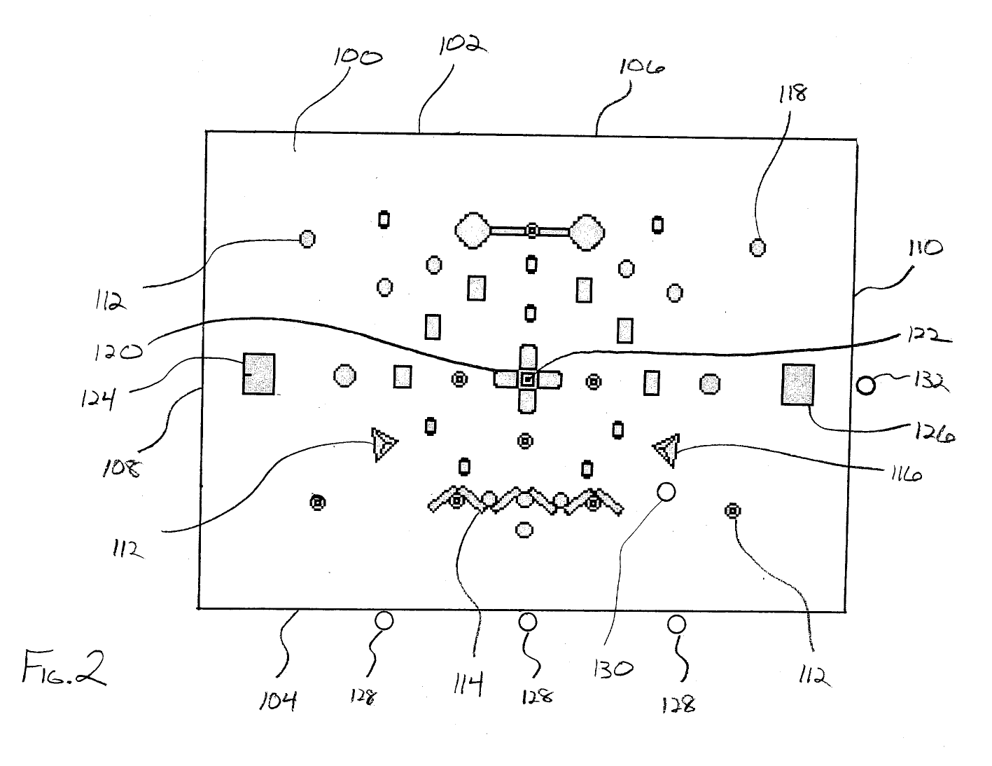

FIG. 2 depicts a playing field 100 as typically used in team paintball events. Playing field 100 is defined by a boundary perimeter 102, most typically having a rectangular shape, made up of a pair of sidelines 104, 106 and a pair of endlines 108, 110. Within playing field 100 are a plurality of bunkers 112. Bunkers 112 provide cover and hiding places for players during a paintball game. Bunkers 112 are available in a wide variety of configurations including a snake bunker 114, a dorito bunker 116, and a beercan bunker 118. Located at the center of playing field 100 is a center fifty bunker 120 that may include a center flag 122. At opposing ends of playing field 100 are a pair of start boxes 124, 126 that may include individual team flags. The teams typically remain within the start boxes 124, 126 until the game is started by the referee. Outside of boundary perimeter 102 along sideline 104 is a plurality of fixed cameras 128. Within playing field 100 is a roving camera 130. Outside of boundary perimeter 102 along endline 110 is an elevated camera 132. It is envisioned that the present invention can be practiced with any number of fixed camera 128, roving camera 130 and elevated camera 132 so long as there is at least one of each camera filming during a game.

Film process 82 is used to film a paintball game occurring on playing field 100. Generally as depicted in FIG. 2, fixed cameras 128 and elevated camera 132 are prepositioned prior to the start of a game. Elevated cameras 132 can be elevated in a variety of ways such as lifting machinery, scaffolding, a tower or other elevating devices. The only requirement for elevated camera 132 is that the field of view encompass the entire playing field 100. Roving camera 130 is typically hand carried by a cameraman filming within playing field 100. All camera operators wear the same protective and safety gear as the players themselves. Generally, two teams will enter playing field 100, each team locating to the appropriate start box 124, 126. Based on a start signal provided by the referee, such as a whistle or horn, the teams will disperse from start boxes 124, 126 and individual players will typically seek cover behind bunkers 112. Prior to the signal, fixed cameras 128, roving camera 130 and elevated camera 132 will have begun recording. Roving camera 130 is hand-carried around playing field 100 to film intense close-up action of players moving and shooting. The field of view of elevated camera 132 must include all of playing field 100 such that elevated camera 132 captures all player movement. Optionally, elevated camera 132 can simultaneously record an audio commentary provided by an operator describing various events on the field such as exciting movement or player eliminations. Fixed cameras 128, roving camera 130 and elevated camera 132 continue to film until a stop signal, such as a horn or whistle, is sounded by the referee signaling the end of the paintball game. Fixed cameras 128, roving camera 130 and elevated camera 132 are most preferably configured to film in a Mini DV format but other formats including VHS, 8 mm, Beta and other typical analog and digital formats could be used as well.

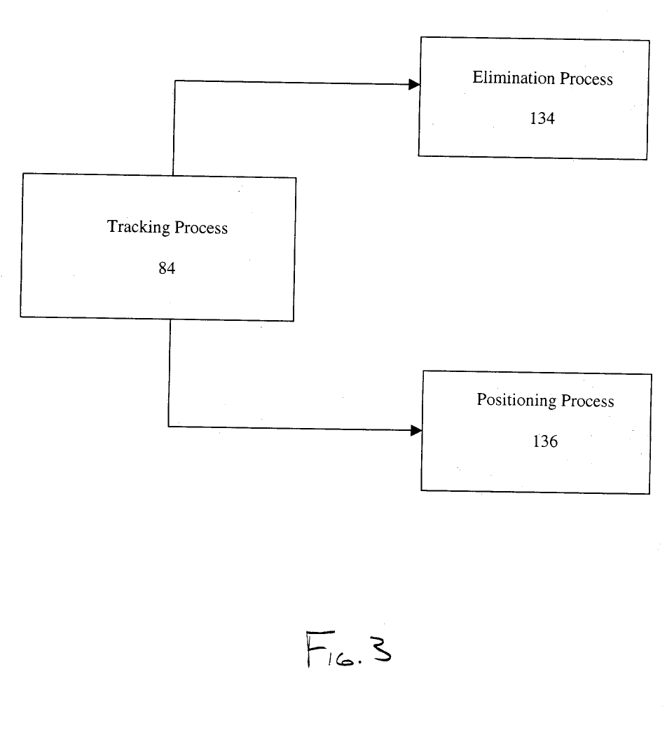

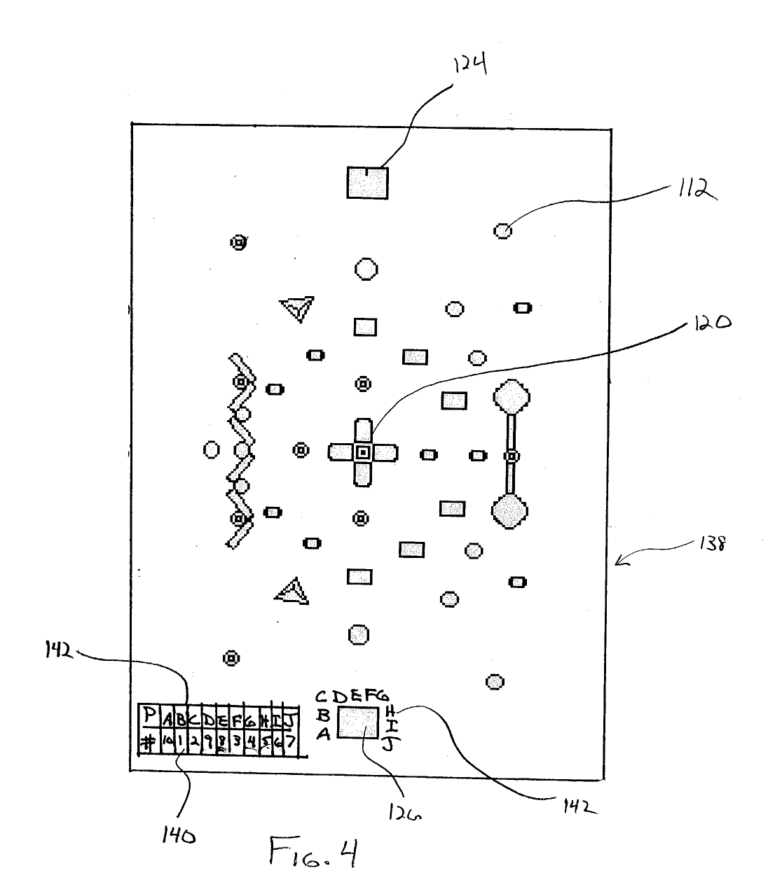

FIG. 3 depicts the methodology of tracking process 84. Once film process 82 is completed, tracking process 84 is commenced. Tracking process 84 typically comprises two sub-sets, an elimination process 134 and a positioning process 136. Prior to commencing either elimination process 134 or positioning process 136, a blank recording device 138 as depicted in FIG. 4 is created. Blank recording device 138 is a two-dimensional representation of a top view of playing field 100 graphically depicting the physical elements including, bunkers 112, center fifty bunker 120 and start boxes 124, 126. Blank recording device 138 can include electronic recording devices for example a tablet PC or can include something as simple as a sheet of paper depicting playing field 100. In addition, a plurality of player designations 140 represented by letters A-J, each corresponding to an individual player 142, during the game are recorded on blank positioning device 138.

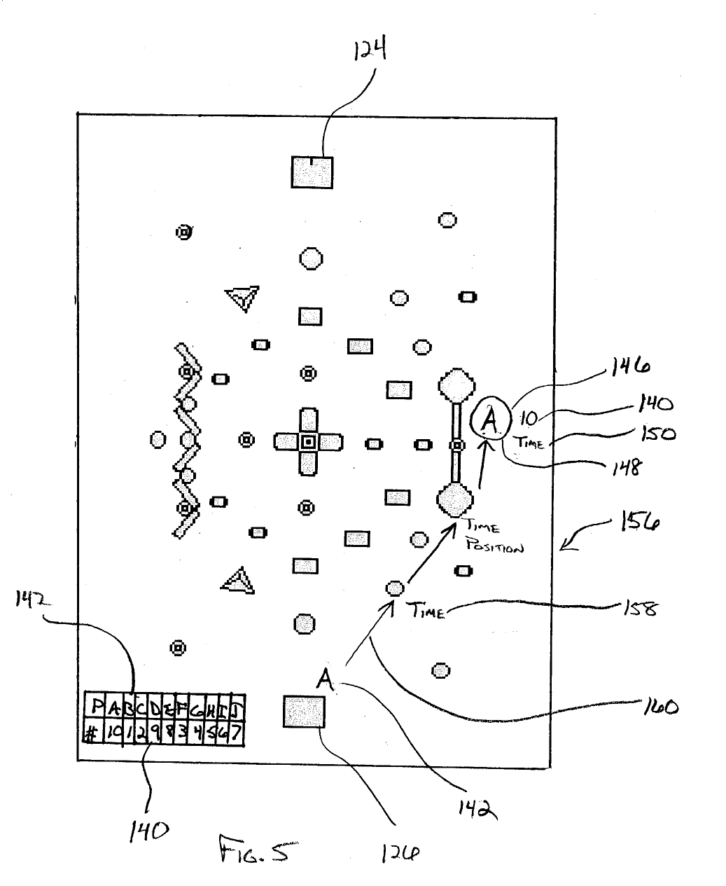

In elimination process 134, an elevated film taken by elevated camera 132 is reviewed for player eliminations 146 captured by the elevated camera 132. Player elimination 146 most typically occurs when a player is shot or removed from playing field 100 by the referee. Elevated film may contain the aforementioned audio commentary making it easier to recognize player eliminations 146. Using blank positioning device 138 as depicted in FIG. 5, player designation 140, a player position 148 and an elimination time 150 are recorded for each elimination 146. For purposes of clarity, FIG. 5 depicts a single player. Similarly, player eliminations 146 are recorded for all players on both teams for accountability purposes to insure that the losing team has in fact lost all of their players while the headcount for the winning team is accurate at the end of the game. If all of the player eliminations 146 are not found in the elevated film, a fixed film filmed by the fixed camera 128 and a roving film filmed by the roving camera 130 may be reviewed as well.

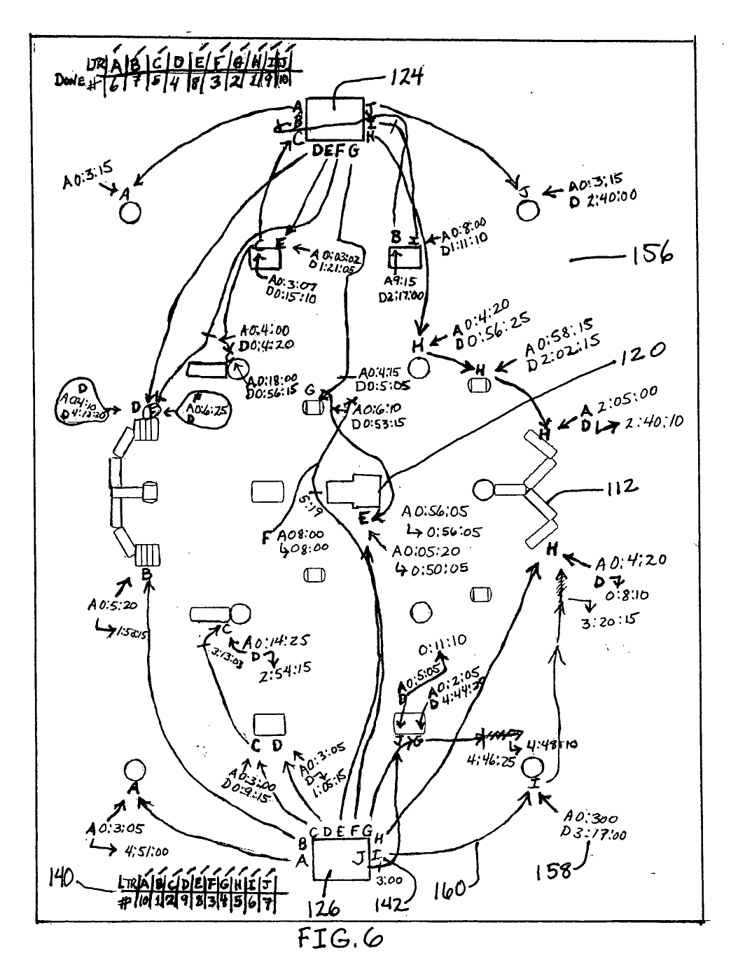

Following the completion of elimination process 134, positioning process 136 is commenced. Blank positioning device 138 is used to create a completed positioning element 156 in which both a time element 158 and a positioning arrow 160 corresponding to the movement of players 142 throughout the game are recorded on blank positioning device 138. For ten-man teams, a completed positioning element 156 will include time element 158 and positioning arrow 160 for twenty players 142 as depicted in FIG. 6. Alternatively, completed positioning element 156 can be created for individual players 142 or individual teams.

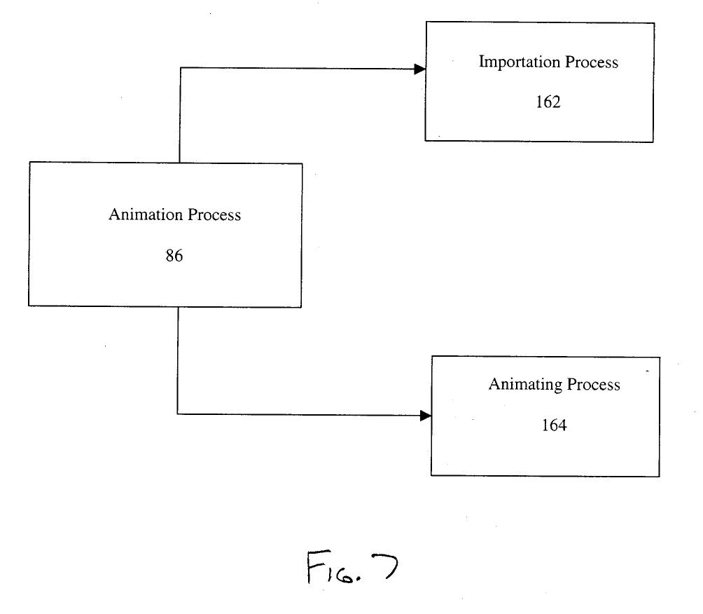

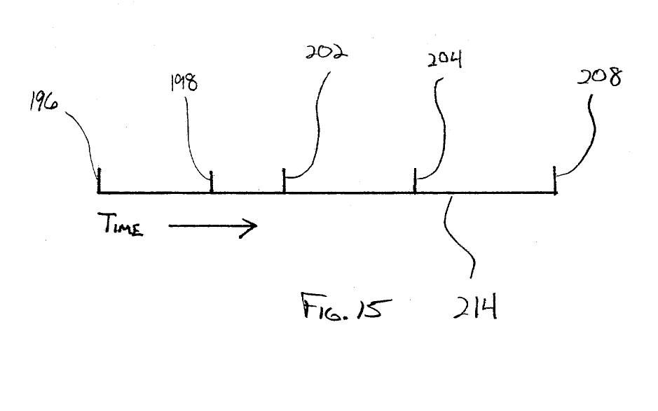

Animation process 86 as depicted in FIGS. 7-15 comprises an importation process 162 and an animating process 164. In importation process 162, an animated overhead view 166 of playing field 100 is created. Animated overhead view 166 resembles blank positioning device 138 but includes graphics and compositions suitable for video depiction on a television or computer screen. Animated overhead view 166 includes animated versions of all physical elements of playing field 100 including bunkers 112, center fifty bunker 120 and start boxes 124, 126. Animated overhead view 160 is downloaded into a graphics and visual effects program. An example of graphics and visual effects program is Adobe® After Effects® software running on a personal computer.

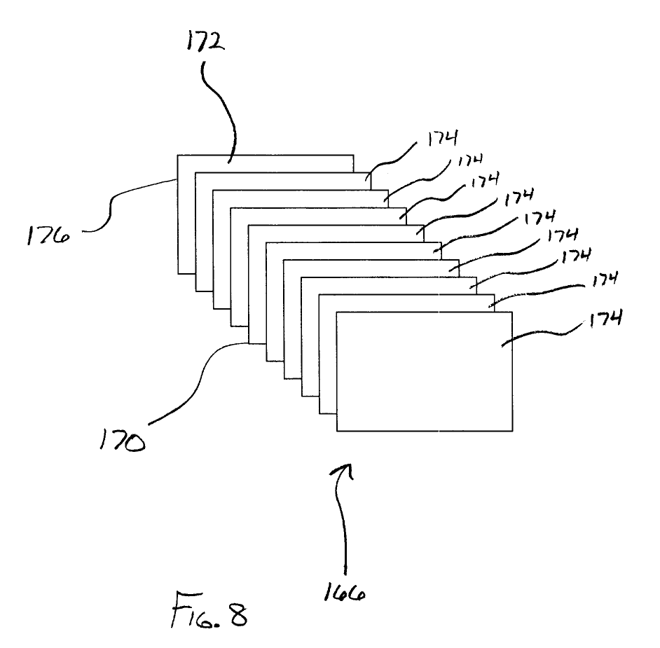

As depicted in FIG. 8, animated overhead view 166 comprises an object stack 170 made of a field layer 172 and a plurality of player layers 174, the number of player layers 174 being equal to the number of players 142. Field layer 172 is designated as a lowest layer 176 of the object stack 170 with player layers 174 being stacked on top of field layer 172. Field layer 172 includes graphical representations of all physical elements of playing field 100 including bunkers 112, center fifty bunker 120 and start boxes 124,126. Each player layer 174 includes an animated player character 178 representing the player 142. Animated player characters 178 are typically represented by colored graphics, whereby teams comprised different colors. The player layers 174 are designated as transparent within the graphics and visual effects program such that nothing obscures field layer 172. Once object stack 170 has been assembled, various layers can be combined into compositions; for instance a first team composition comprising all player layers 174 from a first team 182, a second team composition comprising all player layers 174 from a second team, or a player composition comprising all player layers 174 regardless of teams.

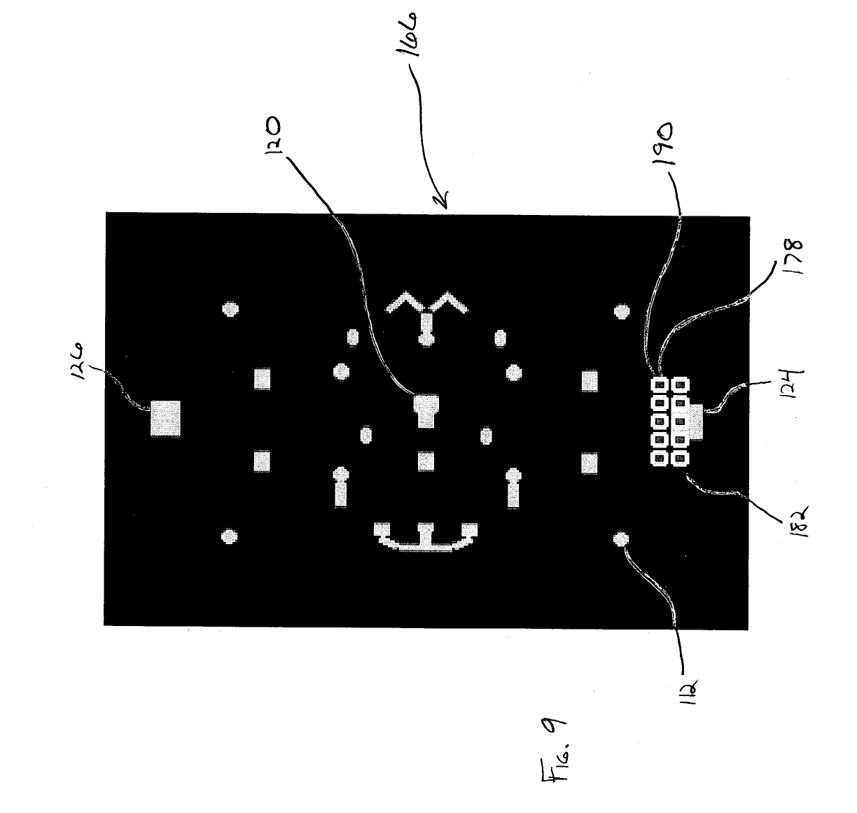

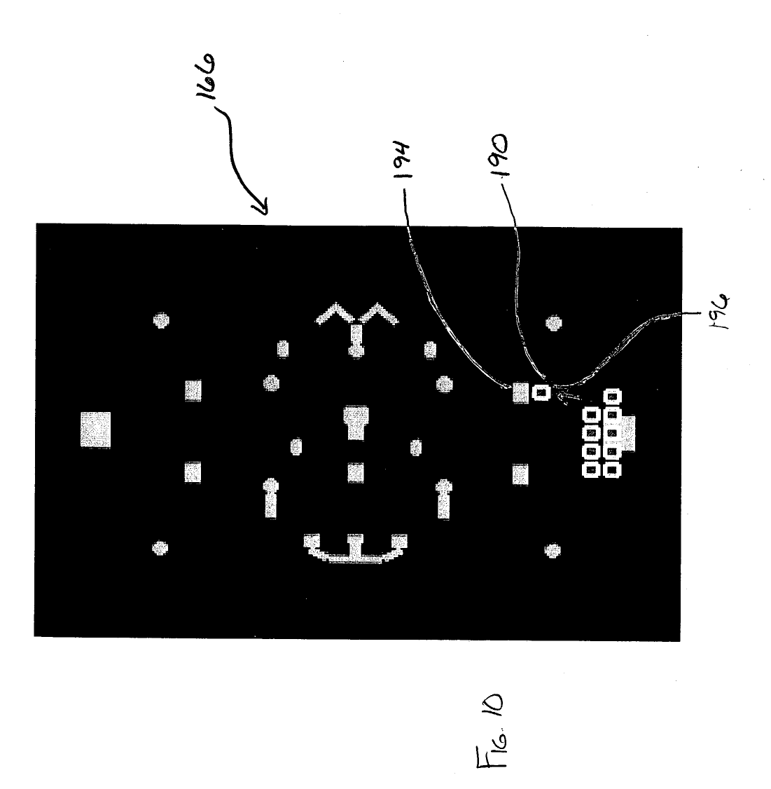

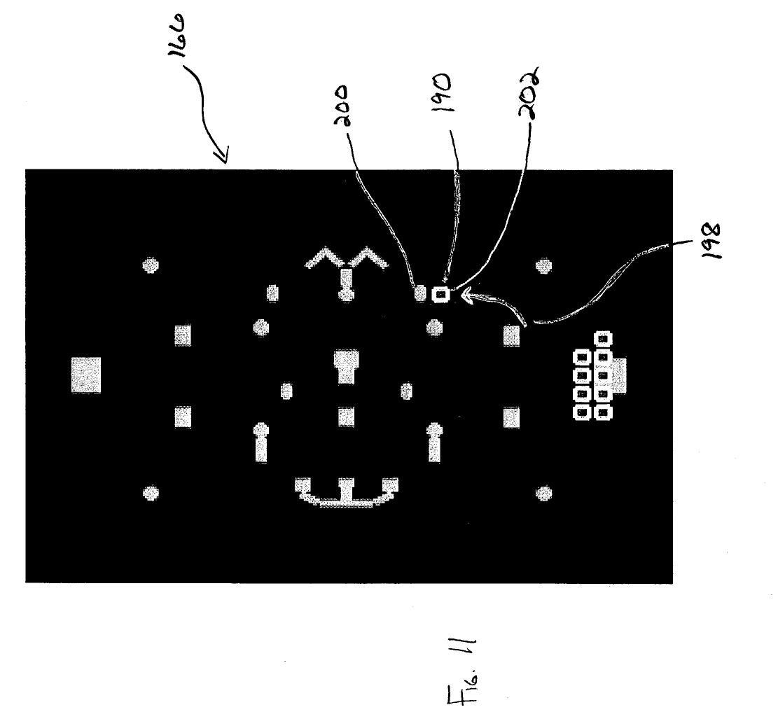

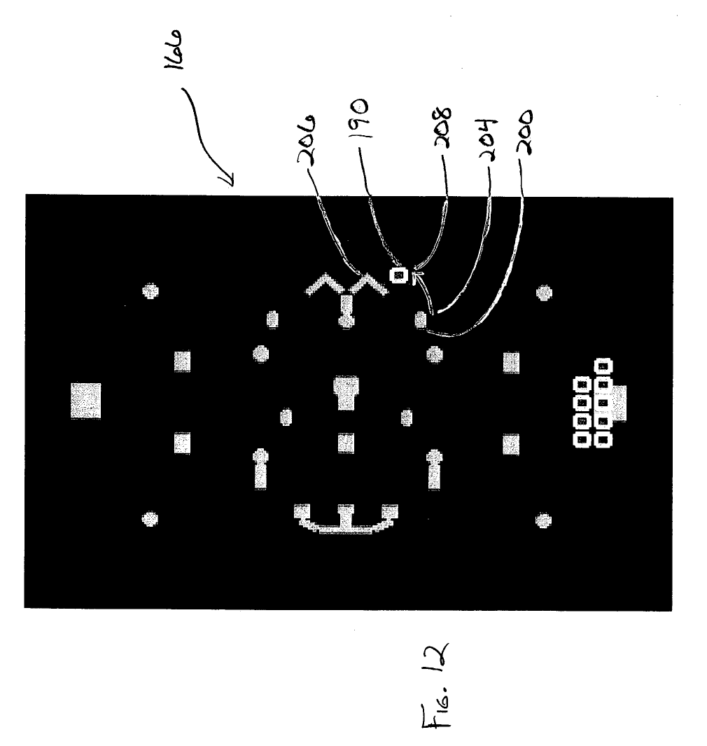

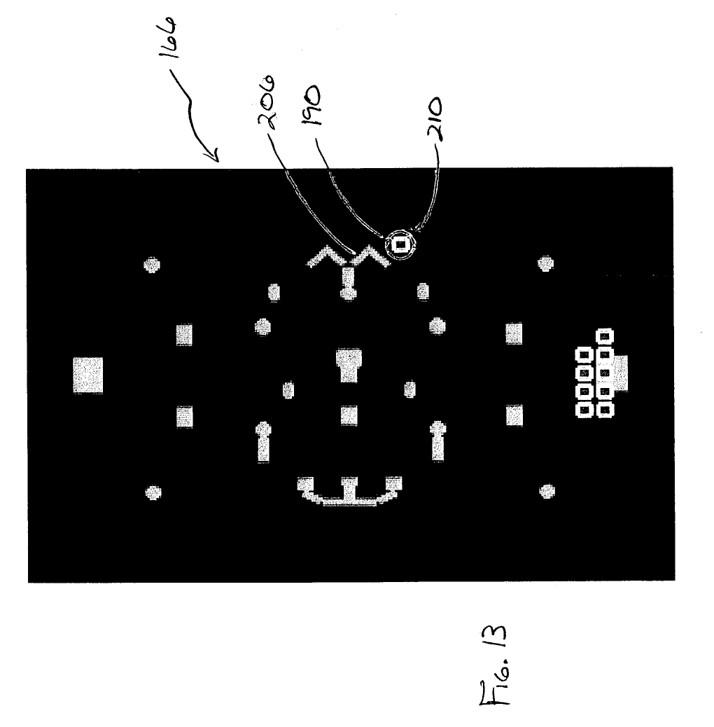

Animating process 164 depicted in FIGS. 9-14 is herein described with reference to movement of a first player 190. First player 190 is individually depicted with animated player character 178 to be at starting box 124 prior to a start time as shown in FIG. 9. Using the completed positioning sheet 156, depicting first player 190 individually for purposes of clarity, it can be seen that first player 190 moves from the starting box 124 at start time to a first bunker 194 at a first time 196 as shown in FIG. 10. First player 190 leaves first bunker 194 at a second time 198 and moves to a second bunker 200, arriving at a third time 202 as shown in FIG. 11. First player 190 leaves second bunker 200 at a fourth time 204 and proceeds to a third bunker 206, arriving at a fifth time 208 as shown in FIG. 12. While at third bunker 206, first player 190 is eliminated at a sixth time 210 as shown in FIG. 13.

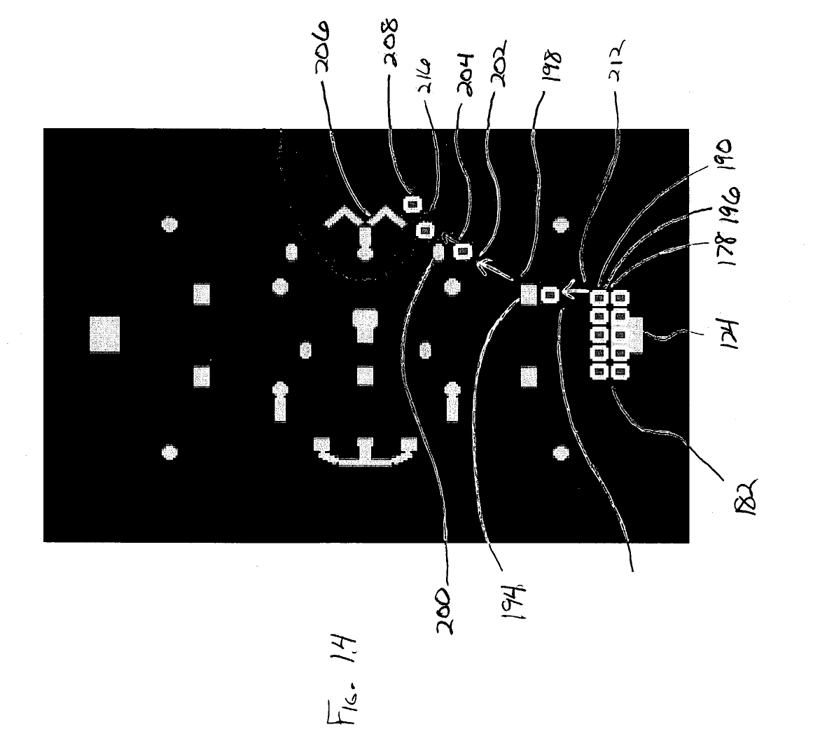

FIG. 14 depicts animated overhead view 166 as graphics and visual effects program is used to graphically animate players 142. For purposes of clarity, the first player 190 is individually depicted though the animation is similar for all remaining players. The first player 190 has a keyframe 212, designated at the start time. Keyframe 212 is herein depicted as an arrow and is individually designated for each player 142 and is used to graphically animate changes in position, velocity, scale or other controllable settings for the players 142. To animate the movement of first player 190 from starting box 124 to first bunker 194, a timeline feature 214 in the graphics and visual effects program is made equal to first time 196 while keyframe 212 is moved to first bunker 194. Keyframe 212 is adjusted within graphics and visual effects program, for example, through use of a computer mouse or other interface. Next, timeline feature 214 is adjusted within graphics and visual effects program via a computer interface to second time 198 while keyframe 212 remains positioned at first bunker 194. This illustrates the waiting period between first time 196 and second time 198. Next, timeline feature 214 is adjusted to third time 202 while keyframe 212 is moved to second bunker 200 to show movement of first player 190 from first bunker 194 to second bunker 200. Once again, timeline feature 214 is adjusted to fourth time 204 while keyframe 212 remains at second bunker 200 to illustrate first player 190 waiting at second bunker 200. Next, timeline feature 214 is adjusted to fifth time 208 while keyframe 212 is positioned at third bunker 206 to illustrate movement of first player 190 from second bunker 200 to third bunker 206. In the event that first player 190 slides into third bunker 206, a slide 216 can be illustrated by adjusting timeline feature 214 to a time just prior to fifth time 208, for instance, two seconds prior to fifth time 208. With timeline feature 214 set one second prior to fifth time 208, keyframe 212 is positioned almost to third bunker 206. The end result is that first player 190 is depicted moving quickly at fourth time 204 followed by the slower movement of slide 216 just prior to reaching third bunker 206 at fifth time 208. Timeline feature 214 is adjusted to sixth time 210 while keyframe 212 remains at third bunker 206 to illustrate first player 190 waiting at third bunker 206. To illustrate the elimination of first player 190, player layer 177 corresponding to first player 190 is given an end time at sixth time 210 whereby first player 190 no longer appears within animated overhead view 166. Following the animation of first player 190, animating process 164 is repeated for every other player 142 resulting in a completed overhead animation 218 graphically depicting all of the information compiled in tracking process 84.

Once animation process 86 is completed, editing process 88 is commenced. Elevated film, fixed films and roving film are downloaded into an editing program. An example of such an editing program is Adobe® Software's Premiere® video editing software used in conjunction with a personal computer. Using the editing program, the film captured by elevated camera 132, fixed cameras 128 and roving camera 130 are reviewed by an editor and sorted for a series of action elements that would provide entertainment or strategy benefits to a viewer. Action elements could comprise scenes of intense shooting, exciting movement, player eliminations or other items that would typically be of interest to a spectator. Action elements are strung together to create a continuous video having a video duration equal to a game duration. The game duration is defined as the time period between a start signal and a stop signal. Video duration must be kept time accurate so that it does not differ from the game duration.

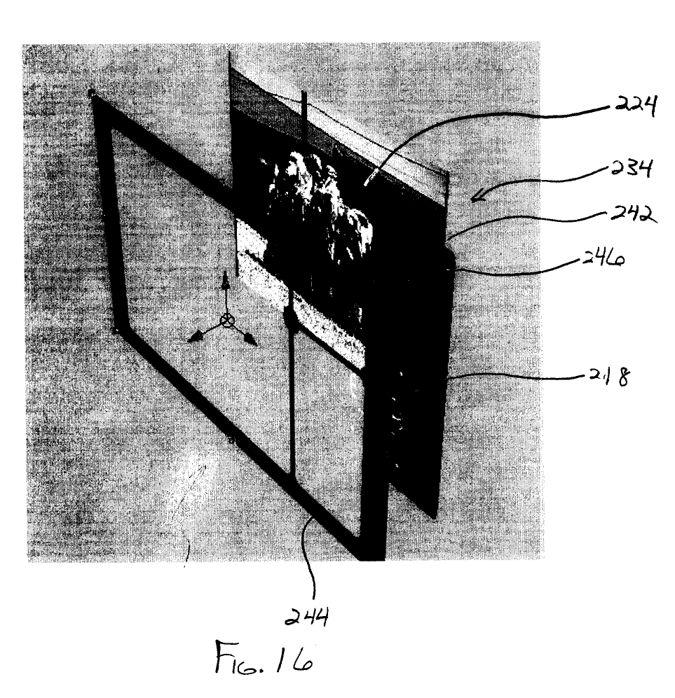

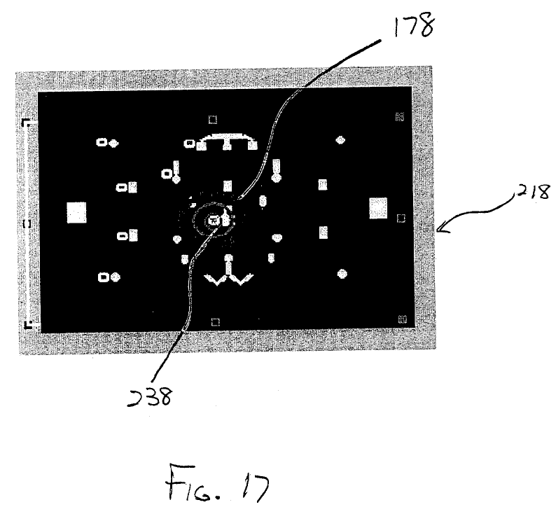

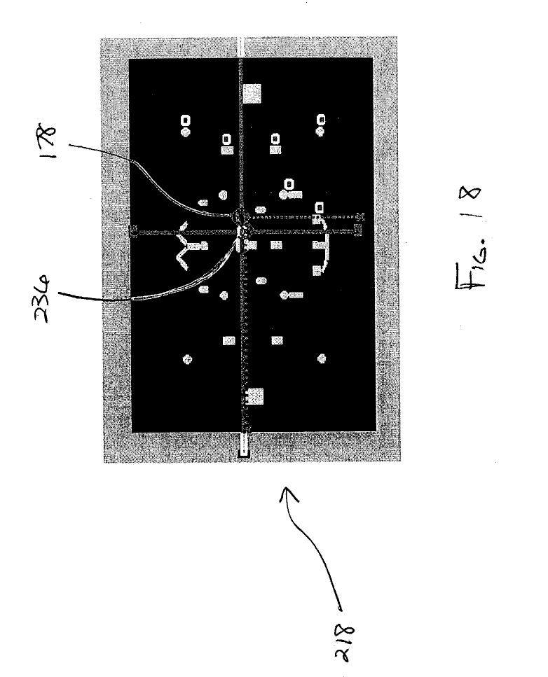

Once continuous video, indicated as item 224 in FIG. 16, is completed, merging process 90 is commenced as depicted in FIG. 16. Continuous video 224 and completed overhead animation 218 are merged into a combined video 234. Combined video 234 is time synchronized such that continuous video 224 and completed overhead animation 218 simultaneously begin at the start signal and simultaneously end at the stop signal. Due to possible filming variations within fixed cameras 128, roving camera 130 and elevated cameras 132, it is possible that continuous video 224 may be up to one second out of sync with completed overhead animation 218. To compensate, keyframe 212 can be slightly adjusted at the start time or at the stop time so that the animated player characters 178 begin and end their movement in conjunction with the continuous video 224. Once combined video 234 is completed, additional effects and features can be added as depicted in FIGS. 17 and 18. One such feature is to highlight player elimination 146 within completed overhead animation 218. For example, a crosshair 236 or a circle 238 could be superimposed over animated player character 178 when eliminated. Circle 238 could further comprise a radar blip represented by a series of different sized circles. Other features could include color changes or other features designed to be eyecatching so as to draw the attention of a viewer.

In a preferred embodiment, combined video 234 comprises continuous video 224 and completed overhead animation 218 in a horizontal, side-by-side arrangement 242. Alternative arrangements could include a vertical top and bottom arrangement or a picture-in-picture arrangement in which, for example, completed overhead animation 218 is present within continuous video 224. Preferably, a border 244 is created and merged into the combined video 234 to provide an aesthetically pleasing look and to further set off and distinguish what is being simultaneously depicted in combined video 234. Border 244 is merged over combined video 234 such that border 244 bounds both continuous video 224 and completed overhead animation 218. Border 244 can also include a display area 246 in which additional, video-specific information such as a game clock, team names, trademarks or other symbols or text can be displayed in conjunction with combined video 234.

While a preferred embodiment of paintball video 80 has been described, various other embodiments will be obvious to one skilled in the art. For example, paintball video 80 can be supplied in a format, for example DVD or CD-ROM, that includes selectable features allowing a viewer to selectively alter the appearance of paintball video 80 during viewing. Selectable features could include an ability to select different audio tracks while paintball video 80 is playing. Another selectable feature could include an ability to modify combined video 234 such that alternate views, i.e. films taken by elevated camera 132, fixed cameras 128 or roving camera 130, could selectively replace continuous video 224 within combined video 234. Another selectable feature could include allowing the viewer to selectively alter animated player characters 178, for example having them appear as skull-and-crossbones, X's, stick figures, different geometric shapes, colors, etc . . . .

Paintball video 80 of the present invention can be used in a variety of ways. Paintball video 80 can function merely as an entertainment vehicle for team paintball participants or interested spectators. Paintball video 80 can also function as a training tool for use by individual teams to review past strategies or to scout the strategies of future competitors. Although various embodiments of the present invention have been disclosed here for purposes of illustration, it should be understood that a variety of changes, modifications and substitutions may be incorporated without departing from either the spirit or scope of the present invention as defined by claims.

1. An apparatus for recording a live action video representation and coordinating it with a graphical representation, the live action activity taking place on a substantially rectilinear playing field, the apparatus comprising:
a fixed field of view, first video camera having a line of sight, the line of sight substantially parallel to a first dimension of the playing field;
a second elevated video camera whose field of view encompasses substantially the entire playing field and whose line of sight is substantially normal to the lines of sight of the first video camera;
a third roving camera whose line of sight and field of view are variable; and
a tracking processor for tracking movement of players.

2. The apparatus as claimed in claim 1 in which the tracking processor further comprises an elimination processor and a positioning processor.

3. The apparatus as claimed in claim 1 further comprising a positioning processor.

4. The apparatus as claimed in claim 1 further comprising an animation processor.

5. The apparatus as claimed in claim 1 in which the animation processor further comprises an importation processor and an animating processor.

6. A video representation of a sporting event taking place on a playing field comprising:
an image of live action play depicting actions of players the time course of which has a one-to-one relationship with the time of the sporting event; and
a time-coordinated animated representation of the live action play depicting an animated overhead view of players in relation to the playing field which identifies each player and depicts each player's movements during the time course of the sporting event, the live action image and the animated representation being simultaneously viewable each in a defined portion of a video display.

7. The video representation of claim 6, in which the sporting event is a paintball competition.

8. The video representation of claim 6, in which the animated representation of each player is individually identified.

9. The video representation of claim 6, in which the animated representation of each player is individually identified by a number corresponding to that player's jersey number.

10. The video representation of claim 6, in which the animated representation of the playing field includes sidelines, endlines, a bunker and a start box.

11. The video representation of claim 6, in which the animated representation graphically displays and indicates eliminated players.

12. The video representation of claim 6, in which the animated representation continuously updates the location of players relative to the playing field in coordination with the live action image.

13. A method for creating a video representation of a sporting event taking place on a playing field comprising the steps of:
recording video imagery of the event with a fixed field of view, first video camera having a line of sight, the line of sight substantially parallel to a first dimension of the playing field;
recording video imagery of the event with a second elevated video camera whose field of view encompasses substantially the entire playing field and whose line of sight is substantially normal to the lines of sight of the first video camera;
recording video imagery of the event with a third roving camera whose line of sight and field of view are variable;
graphically representing the playing field in an animation;
graphically representing players in the animation as they move on the playing field; and
merging selected video imagery and the graphical animation into a coordinated display so that the video imagery and the graphical animation are simultaneously viewable each in a defined portion of a video display.

14. The method of claim 13 in which the coordinated display has a one-to-one time correspondence to the sporting event.

15. The method of claim 13 further comprising the step of individually identifying at least one player on the graphical representation.

16. The method of claim 13 further comprising the step of individually identifying at least one player on the graphical representation by that player's jersey number.

17 The method of claim 13 further comprising the step of graphically representing portions of the playing field including sidelines, endlines, a bunker and a start box.

18. The method of claim 13 further comprising the step of graphically identifying eliminated players.

19 The method of claim 13 further comprising the step of continuously updating the location of players relative to the playing field in coordination with the live action image.
